(19) United States
(12) Patent Application Publication
(10) Pub. No.: US 2022/0215493 A1
(43) Pub. Date: Jul. 7, 2022

(54) Method, Apparatus, and Electronic Device for Obtaining Trademark Similarity

(71) Applicant: Alibaba Group Holding Limited, Grand Cayman (KY)

(72) Inventors: Yingchi Liu, Hangzhou (CN); Quanzhi Li, Hangzhou (CN); Changlong Sun, Hangzhou (CN)

(21) Appl. No.: 17/563,960

(22) Filed: Dec. 28, 2021

(30) Foreign Application Priority Data
Jan. 4, 2021 (CN) 202110004420.7

(51) Int. Cl. G06Q 50/18

(52) U.S. Cl. CPC G06Q 50/184

(57) ABSTRACT

A method for obtaining trademark similarity is disclosed, and includes: obtaining character information of a first trademark and character information of a second trademark; constructing a feature information set according to the character information of the first trademark and the character information of the second trademark; and obtaining a degree of similarity between the first trademark and the second trademark based on the feature information set. By automatically constructing multiple pieces of feature information for evaluating trademark similarity, the method can quickly and accurately obtain a degree of similarity between trademarks, and at the same time, can also avoid the problems of manual design rules or inaccurate calculation of manual design rules.

### CROSS REFERENCE TO RELATED PATENT APPLICATIONS

This application claims priority to Chinese Patent Application No. 202110004420.7, filed on 4 Jan. 2021 and entitled “Method, Apparatus, and Electronic Device for Obtaining Trademark Similarity,” which is hereby incorporated by reference in its entirety.

### TECHNICAL FIELD

The present disclosure relates to the field of natural language processing technology, and in particular, to methods, apparatuses, and electronic devices for obtaining trademark similarity. The present application also relates to methods of pre-judging conflicts between trademark applications.

### BACKGROUND

A trademark (trade mark) is a mark used to distinguish a brand or service of an operator from products or services of other operators. In the increasingly fierce market competition, the value of a trademark has become more and more important.

At present, for a trademark to be applied for, before a company or individual makes a formal application, or when a trademark examiner examines the trademark to be applied, a search in a registered trademark database may generally be performed using an electronic device to confirm whether a trademark similar to the trademark to be applied for exists, i.e., a conflicting trademark, thereby generating a pre-judgment result or review result for that pending application.

However, at present, when using an electronic device to search for trademarks similar to a trademark to be applied for, only simple rules are generally used for performing searches, and search results are not accurate, which usually require and consume labor and time for secondary confirmation. Therefore, existing methods of obtaining trademark similarity has a problem of low accuracy.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer readable instructions as permitted by the context above and throughout the present disclosure.

One purpose of the embodiments of the present disclosure is to provide a new technical solution for quickly and accurately obtaining trademark similarity.

The present disclosure provides a method for obtaining trademark similarity, which includes:

obtaining character information of a first trademark and character information of a second trademark;

constructing a feature information set according to the character information of the first trademark and the character information of the second trademark; and

obtaining a degree of similarity between the first trademark and the second trademark based on the feature information set.

In implementations, constructing the feature information set according to the character information of the first trademark and the character information of the second trademark includes:

obtaining a first character set according to the character information of the first trademark, and obtaining a second character set according to the character information of the second trademark; and constructing the feature information set according to the first character set and the second character set.

In implementations, constructing the feature information set according to the first character set and the second character set includes:

calculating a union of the first character set and the second character set to obtain a target character set;

obtaining an initial character vector based on the target character set, wherein each character of the initial character vector corresponds to characters in the target character set in sequence, and a value of each character of the initial character vector is a first predetermined value;

obtaining a first character vector based on the first character set and the initial character vector, and obtaining a second character vector based on the second character set and the initial character vector; and constructing the feature information set based on the first character vector and the second character vector.

In implementations, obtaining the first character vector based on the first character set and the initial character vector includes:

setting a value of a character at a corresponding position in the initial character vector to a second preset value to obtain the first character vector according to the first character set and a correspondence relationship between each character of the initial character vector and the characters in the target character set.

In implementations, constructing the feature information set based on the first character vector and the second character vector includes:

constructing the feature information set by calculating a cosine similarity of the first character vector and the second character vector.

In implementations, constructing the feature information set based on the first character set and the second character set includes:

calculating a Jaccard coefficient between the first character information and the second character information based on the first character set and the second character set; and

constructing the feature information set based on the Jaccard coefficient.

In implementations, constructing the feature information set based on the first character set and the second character set includes:

constructing the feature information set by calculating an edit distance between the first character information and the second character information.

In implementations, constructing the feature information set based on the first character set and the second character set includes:

obtaining a first length of the first character set and a second length of the second character set;

constructing the feature information set by calculating an absolute value of a difference between the first length and the second length and an average value of the first length and the second length.

In implementations, obtaining the degree of similarity between the first trademark and the second trademark based on the feature information set includes:

inputting feature information in the feature information set into a similarity calculation model to obtain the degree of similarity.

In implementations, the first character information includes one or more of Chinese character information, pinyin information, and phrase information corresponding to the first trademark; and correspondingly, the second character information includes one or more of Chinese character information, pinyin information, English information, and phrase information corresponding to the second trademark.

The present disclosure also provides a method for pre-judging conflicts between trademark applications, which includes:

obtaining a target trademark to be applied for;

obtaining a set of similar trademarks corresponding to the target trademark;

obtaining a similarity set based on the target trademark and the set of similar trademarks, wherein a degree of similarity in the similarity set represents a degree of similarity between the target trademark and a trademark in the set of similar trademarks, and the degree of similarity is obtained using the method described in the first aspect of the present disclosure; and obtaining a pre-judgment application result of the target trademark based on the similarity set.

In implementations, the method further includes:

generating a list of similar trademarks based on the set of similar trademarks and the similarity set, wherein the list of similar trademarks includes a plurality of data pairs, and the plurality of data pairs are formed by trademarks in the set of similar trademarks and degrees of similarity in the similarity set corresponding to the trademarks.

In implementations, the method is applied to a server, and the method further includes:

providing the list of similar trademarks and the pre-judgment application result to a terminal device.

In implementations, the method is applied to a terminal device, and the method further includes:

displaying the list of similar trademarks and the pre-judgment application result.

According to the present disclosure, an apparatus for obtaining trademark similarity is also provided, which includes:

a character information obtaining module configured to obtain character information of a first trademark and character information of a second trademark;

a feature information set construction module configured to construct a feature information set based on the character information of the first trademark and the character information of the second trademark; and a similarity obtaining module configured to obtain a degree of similarity between the first trademark and the second trademark based on the feature information set.

According to the present disclosure, an electronic device is also provided, which includes the apparatus according to the third aspect of the present disclosure; or includes:

a memory configured to store executable instructions;

a processor configured to run the electronic device to execute the method according to the first aspect or second aspect of the present disclosure under the control of the executable instructions.

According to the present disclosure, a computer readable storage medium is also provided. The computer readable storage medium stores a computer program that is readable and executable by a computer. When read and run by the computer, the computer program executes the method according to the first or second aspect of the present disclosure.

According to the embodiments of the present disclosure, when a degree of similarity between two trademarks is needed to be obtained, an electronic device separately obtains character information of a first trademark and character information of a second trademark for the first trademark and the second trademark, and constructs a feature information set based on the character information of the first trademark and the character information of the second trademark. In this way, the electronic device may quickly and accurately obtain a degree of similarity between the first trademark and the second trademark based on the feature information set. In the embodiments of the present disclosure, the electronic device obtains character information of the trademarks and automatically constructs multiple pieces of feature information for judging a degree of similarity between trademarks, which may quickly and accurately obtain the degree of similarity between the trademarks, and may also avoid manual design rules or the problem of inaccurate calculation due to the manual design rules at the same time, thereby saving manpower and improving user experience.

Through the following detailed description of exemplary embodiments of the present disclosure with reference to accompanying drawings, other features and advantages of the present disclosure will become clear.

### BRIEF DESCRIPTION OF THE DRAWINGS

The drawings that are incorporated in the specification and constitute a part of the specification illustrate the embodiments of the present disclosure, and serve to explain the principles of the present disclosure together with the description thereof.

FIG. 1 is a schematic diagram of a scenario of a method for obtaining trademark similarity provided by the embodiments of the present disclosure.

FIG. 2 is a hardware configuration diagram of an electronic device that may be used to implement the method for obtaining trademark similarity in the embodiments of the present disclosure.

FIG. 3 is a schematic flowchart of a method for obtaining trademark similarity provided by the embodiments of the present disclosure.

FIG. 4 is a schematic flowchart of a method for pre-judging conflicts between trademark applications provided by the embodiments of the present disclosure.

FIG. 5 is a schematic principle block diagram of an apparatus for obtaining trademark similarity provided by the embodiments of the present disclosure.

FIG. 6a is a schematic functional block diagram of an electronic device according to an embodiment of the present disclosure.

FIG. 6b is a schematic functional block diagram of an electronic device according to another embodiment of the present disclosure.

### DETAILED DESCRIPTION

Various exemplary embodiments of the present disclosure will now be described in detail with reference to the accompanying drawings. It should be noted that relative arrangements of components and steps, numerical expressions and numerical values that are set forth in these embodiments do not limit the scope of the present disclosure, unless specifically stated otherwise.

The following description of at least one exemplary embodiment is only illustrative actually, and in no way serves as any limitation to the present disclosure and its applications or uses.

Technologies, methods, and devices that are known to one of ordinary skill in the related art may not be discussed in detail, but whenever appropriate, the technologies, methods, and devices should be regarded as a part of the specification.

In all examples shown and discussed herein, any specific value should be interpreted as merely exemplary, and not as a limitation. Therefore, other examples of the exemplary embodiments may have different values.

It should be noted that similar reference numerals and letters indicate similar items in the following drawings. Therefore, once an item is defined in a drawing, it does not need to be further discussed in subsequent drawings.

For a problem of a low accuracy rate of electronic when searching for similar trademarks and a time consuming issue caused by the need for manual secondary confirmation devices in existing technologies, the embodiments of the present disclosure provide a method for obtaining trademark similarity, so that an electronic device may quickly and accurately obtain a degree of similarity between two trademarks, thereby improving the accuracy of trademark search results.

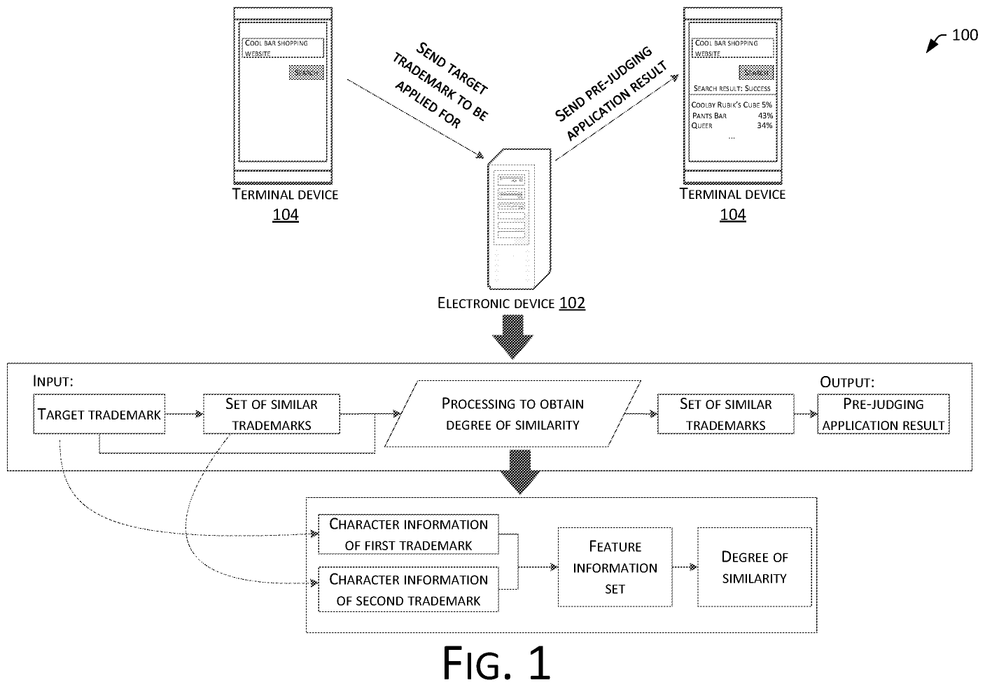

FIG. 1 is a schematic diagram of an application scenario 100 of a method for obtaining trademark similarity provided by the embodiments of the present disclosure. As shown in FIG. 1, for a target trademark to be applied for, for example, a trademark of “Cool Bar Shopping Website”, when a user searches for a registered trademark similar to the target trademark through an electronic device 102, the user may send the target trademark through a terminal device 104 to the electronic device 102, for example, send to a server. After obtaining the target trademark, the electronic device 102 may first follow simple rules, for example, first search for a set of similar trademarks corresponding to the target trademark according to Chinese character matching and/or pinyin matching rules under a trademark classification corresponding to the target trademark. Subsequently, in order to improve the accuracy and reduce the time-consuming issue caused by manual secondary confirmation, the electronic device 102 may regard the target trademark as a first trademark and regard trademarks in the set of similar trademarks successively as a second trademark. By obtaining character information of the first trademark and character information of the second trademark, a feature information set that includes multiple pieces of feature information is constructed, and a degree of similarity between the first trademark and the second trademark is then obtained based on the feature information set with. A similarity set may be obtained by obtaining a degree of similarity between the target trademark and each similar trademark in the set of similar trademarks one by one. Based on the similarity set, the electronic device 102 may quickly and accurately obtain a pre-judged application result for the target trademark, for example, may output a pre-judged application result that directly characterizes “success” or “failure” based on whether a statistical value such as a maximum value or an average value in the similarity set is greater than a preset similarity threshold. The electronic device 102 may also generate a list of similar trademarks based on the set of similar trademarks and the similarity set. Moreover, to facilitate viewing by a user, the electronic device 102 may provide the terminal device 104 with the list of similar trademarks and the pre-judgment application result, to allow the terminal device 104 to display the list of similar trademarks and the pre-judgment application result for the user to view.

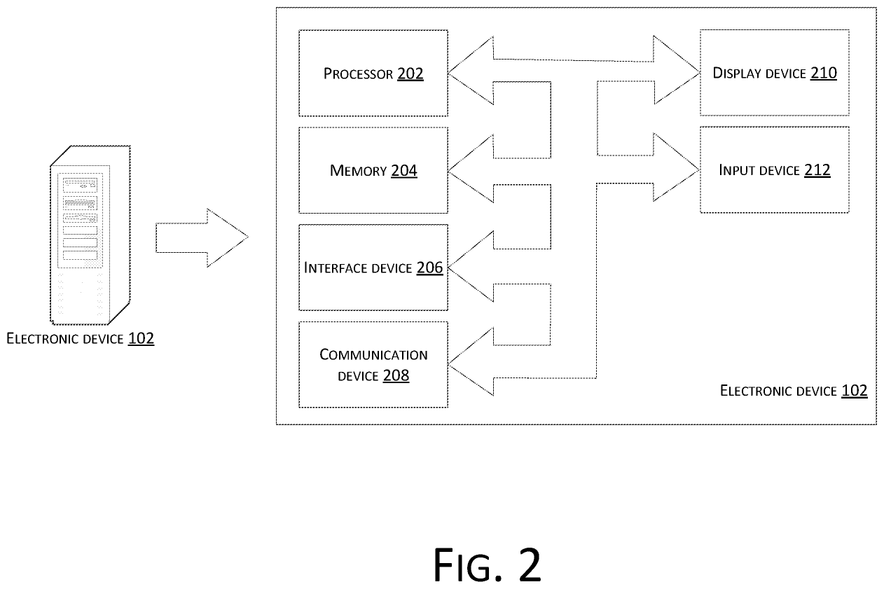

FIG. 2 is a hardware configuration diagram of an alternative electronic device that may be used to implement the method for obtaining trademark similarity according to the embodiments of the present disclosure.

As shown in FIG. 2, the method for obtaining trademark similarity provided in this embodiment may be applied to an electronic device 102. In implementations, the electronic device 102 may be a server or a terminal device, which is not specifically limited herein.

When the electronic device 102 is a server, the server may be a blade server, a rack server, etc. Such server may also be a server cluster deployed in the cloud, which is not limited herein.

As shown in FIG. 2, the electronic device 102 may include a processor 202, a memory 204, an interface device 206, a communication device 208, a display device 210, and an input device 212. The processor 202 may be, for example, a central processing unit (CPU) or the like. The memory 204 includes, for example, ROM (Read Only Memory), RAM (Random Access Memory), non-volatile memory such as a hard disk, and the like. The interface device 206 includes, for example, a USB interface, a serial interface, and the like. The communication device 208 may perform wired or wireless communication, for example. The display device 210 is, for example, a liquid crystal display. The input device 212 may include, for example, a touch screen, a keyboard, and the like.

In this embodiment, the electronic device 102 may be used to participate in implementing the method for obtaining trademark similarity according to any embodiment of the present disclosure.

Applying in the embodiments of the present disclosure, the memory 204 of the electronic device 102 is configured to store instructions. The instructions are used to control the processor 202 to perform operations to support and implement the method for obtaining trademark similarity according to any embodiment of the present disclosure. Technicians may design instructions according to the solutions disclosed in this disclosure. How the instructions control the processor to perform operations is well known in the art, and so is not described in detail herein.

One skilled in the art should understand that, although multiple devices of the electronic device 102 are shown in FIG. 2, the electronic device 102 of the embodiments of the present disclosure may only involve some of the devices, for example, only the processor 202 and the memory 204.

In addition, when the electronic device 102 is a terminal device, the terminal device may be a smart phone, a portable computer, a desktop computer, a tablet computer, etc., which is not specifically limited herein.

It should be noted that the method provided in this embodiment may be independently applied to the electronic device 102, that is, in a server or a terminal device, or may be applied in an interaction scenario between a terminal device and a server according to needs, and there is no special restriction herein.

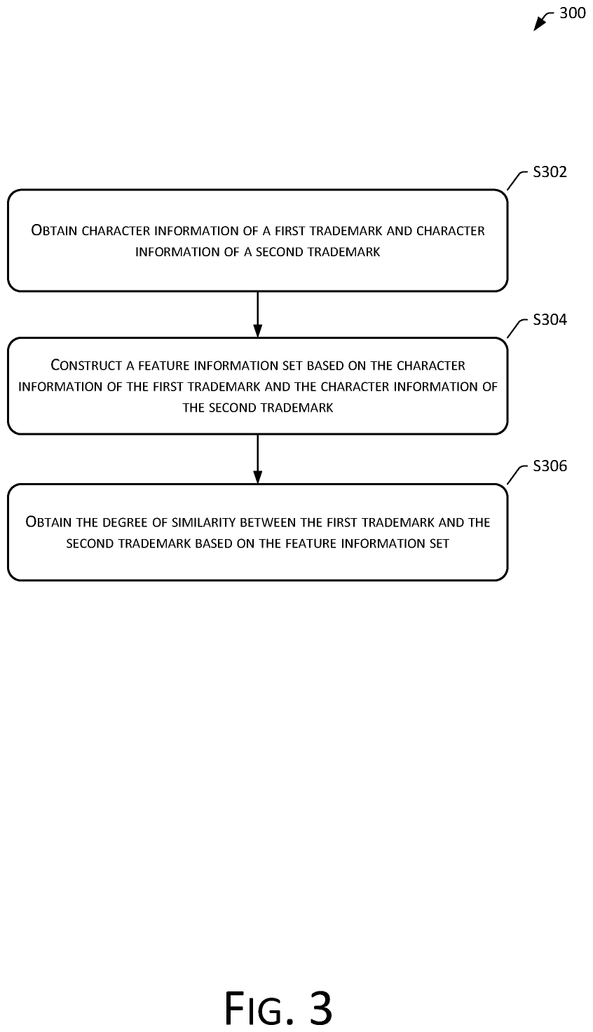

FIG. 3 is a schematic flowchart of a method 300 for obtaining trademark similarity provided by the embodiments of the present disclosure. The method provided in this embodiment may be applied in an electronic device, for example, may be applied in the electronic device 102 as shown in FIG. 2.

As shown in FIG. 3, the method 300 for obtaining trademark similarity in this embodiment may include the following steps S302-S306, which will be described in detail below.

Step S302: Obtain character information of a first trademark and character information of a second trademark.

A trademark (trade mark) may include text, graphics, letters, numbers, three-dimensional signs, sounds, color combinations, or a combination of the above elements. In this embodiment, unless specified otherwise, a trademark is a character trademark. In other words, a trademark composed of characters, such as Chinese characters, numbers, letters, etc., is used as an example for description. Apparently, in implementations, other types of trademarks may also be processed by the method described in this embodiment. For example, for trademarks including graphics, sounds, etc. trademarks of these categories may be converted into character trademarks by recognizing characters in the graphics or characters in the sound, or a degree of similarity between trademarks may be obtained in conjunction with methods such as a method of obtaining image similarity degree, a method of obtaining audio similarity degree, etc. There is no special restriction herein.

The first trademark and the second trademark may be two arbitrary trademarks to be calculated for trademark similarity. For example, the first trademark may be “Cool Bar Shopping Website”, and the second trademark may be “Pants Bar”. There is no special restriction herein.

In this embodiment, the character information of the first trademark includes one or more of Chinese character information, pinyin information, and phrase information corresponding to the first trademark. Correspondingly, the character information of the second trademark includes one or more of Chinese character information, pinyin information, English information, and phrase information corresponding to the second trademark.

For example, for a trademark of “Cool Bar Shopping Website”, corresponding character information may be Chinese character information “cool, bar, shopping, goods, web, site”; or pinyin information “ku, ba, gou, wu, wang, zhan”; or one or more of phrase information “cool bar, shopping, website”.

In this embodiment, in order to improve the accuracy of calculation of trademark similarity, character information of each trademark including Chinese character information, pinyin information, and phrase information is used as an example. In other words, in this embodiment, similarity feature information in the three aspects of Chinese character, pinyin and phrase is separately extracted for the two trademarks to be calculated for similarity, to obtain a degree of similarity between the two trademarks.

In implementations, pinyin information of a trademark may be obtained by converting Chinese characters in the trademark into pinyin, while English text remains unchanged. Phrase information of the trademark may be obtained by segmenting the Chinese characters in the trademark. How to segment words from a character text is not redundantly described herein.

Step S304: Construct a feature information set based on the character information of the first trademark and the character information of the second trademark.

In this embodiment, the feature information set includes multiple pieces of feature information, and the feature information includes information that characterizes a degree of similarity between the character information of the first trademark and the character information of the second trademark.

After obtaining the two trademarks to be calculated for similarity and the character information of the two trademarks through step S302, the electronic device may construct multiple pieces of feature information that characterizes the degree of similarity between these two types of character information from various aspects based on the character information of the first trademark and the character information of the second trademark. For example, the feature information may be constructed from the three aspects of Chinese characters, pinyin, and phrases, which will be described in detail below.

In implementations, constructing the feature information set based on the character information of the first trademark and the character information of the second trademark includes: obtaining a first character set based on the character information of the first trademark, and obtaining a second character set based on the character information of the second trademark; and constructing the feature information set based on the first character set and the second character set.

In this embodiment, the first character set includes characters corresponding to the first trademark, and the second character set includes characters corresponding to the second trademark.

For example, when the first trademark is “Cool Bar Shopping Website” and the second trademark is “Pants Bar”, in terms of Chinese characters, the character information of the first trademark may be “cool, bar, shopping, goods, web, site”, the character information of the second trademark may be “pants, bar”. In this case, the first character set may be {cool, bar, shopping, goods, web, site}, and the second character set may be {pants, bar}. In terms of pinyin, the character information of the first trademark may be “ku, ba, gou, wu, wang, zhan”, the character information of the second trademark may be “ku, ba”. In this case, the first character set may be {ku, Ba, gou, wu, wang, zhan}, the second character set may be {ku, ba}. In terms of phrases, the character information of the first trademark may be “cool bar, shopping, web site”, and the character information of the second trademark may be “pants bar”, the first character set may be {cool bar, shopping, web site}, and the second character set may be {pants bar}.

After the first character set and the second character set are obtained, multiple pieces of feature information representing the degree of similarity between the character information of the first trademark and the character information of second trademark may be automatically constructed based on elements in the set(s) to obtain the feature information set.

Specifically, constructing the feature information set based on the first character set and the second character set includes: calculating a union of the first character set and the second character set to obtain a target character set; obtaining an initial character vector based on the target character set, wherein each character of the initial character vector corresponds to a character in the target character set successively, and a value of each character of the initial character vector is a first preset value; obtaining a first character vector based on the first character set and the initial character vector, and obtaining a second character vector based on the second character set and the initial character vector; and constructing the first character vector and the second character vector based on the feature information set.

The first trademark as “Cool Bar Shopping Website” and the second trademark as “Pants Bar” are used as examples for illustration. From the aspect of Chinese characters, a target character set corresponding to the first trademark and the second trademark is {cool, bar, shopping, goods, web, site, pants} by calculating a union of the first character set and the second character set as described above, and when the first preset value is “0”, an initial character vector may be [0000000]. From the aspect of pinyin, a target character set may be {ku, ba, gou, wu, wang, zhan}, and an initial character vector may be [000000]. From the aspect of phrases, a target character set may be {cool bar, shopping, web site, pants bar}, and an initial character vector may be [0000].

In implementations, obtaining the first character vector according to the first character set and the initial character vector includes: setting a value of a character at a corresponding position in the initial character vector to a second preset value to obtain the first character vector based on the first character set and a correspondence relationship between each character of the initial character vector and characters in the target character.

For example, when the first trademark is “Cool Bar Shopping Website”, according to the above description, its first character set is {cool, bar, shopping, goods, web, site} in terms of Chinese characters. In this case, when the second preset value is “1”, according to a correspondence relationship between each character in the initial character vector and characters in the target character set (i.e., the first position corresponds to “cool”, the second position corresponds to “bar”, and the third position corresponds to “shopping”, the fourth position corresponds to “goods”, the fifth position corresponds to “web”, the sixth position corresponds to “site”, and the seventh position corresponds to “pants”), the first character vector may be obtained as [1111110]. Correspondingly, in terms of pinyin, the first character vector may be [111111]. In terms of phrases, the first character vector may be [1110].

For another example, for the second trademark of “Pants Bar”, in terms of Chinese characters, the second character vector may be [0100001]. In terms of pinyin, the second character vector may be [110000]. In terms of phrases, the second character vector may be [0001].

It should be noted that, in implementations, the correspondence relationship between each character of the initial character vector and the characters in the target character set, the first preset value, and the second preset value may also be set as needed. No special restriction is made herein.

After the above processing, the first character vector of the first trademark and the second character vector of the second trademark are obtained, and the feature information set may be constructed based on the first character vector and the second character vector. Specifically, constructing the feature information set based on the first character vector and the second character vector includes: constructing the feature information set by calculating a cosine similarity of the first character vector and the second character vector.

A cosine similarity is to evaluate a degree of similarity between two adjacent vectors by calculating a cosine value of an angle between two vectors.

In other words, the degree of similarity of the two trademarks may be characterized by calculating a cosine similarity between the first character vector of the first trademark and the second character vector of the second trademark.

For example, from the aspect of Chinese characters, the cosine similarity of the first character vector [1111110] and the second character vector [0100001] may be calculated. As such, from the aspect of Chinese characters, the feature information that characterizes the degree of similarity, i.e., word similarity, between the character information of the two trademarks may be obtained. From the aspect of pinyin, the cosine similarity of the first character vector [111111] and the second character vector [110000] is calculated. As such, from the aspect of pinyin, the feature information that characterizes the degree of similarity, i.e., pin yin similarity, between the character information of the two trademarks is obtained. From the aspect of phrases, the cosine similarity of the first character vector [1110] and the second character vector [0001] is calculated. As such, from the aspect of phrases, the feature information that characterizes the degree of similarity, i.e., phrase similarity, between the character information of the two trademarks is obtained. After obtaining the above-mentioned feature information, one or more of the above-mentioned feature information may be used to construct feature information in the feature information set corresponding to the first trademark “Cool Bar Shopping Website” and the second trademark “Pants Bar”.

First and second character sets corresponding to the character information of the first trademark and the character information of the second trademark are respectively obtained above to construct respective character vectors, thereby constructing feature information in corresponding feature information sets. In this embodiment, it is also possible to construct other feature information based on the first character set and the second character set. Specifically, constructing the feature information set based on the first character set and the second character set includes: calculating a Jaccard coefficient between the first character information and the second character information based on the first character set and the second character set; and constructing the feature information set based on the Jaccard coefficient.

A Jaccard coefficient (Jaccard similarity coefficient) may be used to compare similarity and difference between limited character sets. Generally speaking, the larger the value of Jaccard coefficient is, the higher the similarity between the character sets. How to calculate a Jaccard coefficient between two character sets is described in detail in existing technologies, which is not repeated herein.

In addition, in implementations, constructing the feature information set based on the first character set and the second character set includes: constructing the feature information set by calculating an edit distance between the first character information and the second character information.

An edit distance, which is also known as Levenshtein distance, is a quantitative measurement of a degree of difference between two character strings. A measurement method is based on a minimum number of processing it needs to turn a character string into another character string. How to calculate an edit distance between two character sets is described in detail in existing technologies, which is not repeated herein.

In implementations, constructing the feature information set based on the first character set and the second character set further includes: obtaining a first length of the first character set and a second length of the second character set; and constructing the feature information set by calculating an absolute value of a difference between the first length and the second length and an average value of the first length and the second length.

Specifically, in order to extract the feature information that characterizes the degree of similarity between the first character information of the first trademark and the second character information of the second trademark from various aspects, statistical data between the first character set and the second character set may also be obtained, for example, an absolute value of a difference in character length, an average value, etc.

For example, for the first trademark of “Cool Bar Shopping Website” and the second trademark of “Pants Bar”, according to the above description, in terms of Chinese characters, the first character set is {cool, bar, shopping, goods, web, site}, the second character set is {pants, bar}. In this case, the first length is 6, and the second length is 2, then the absolute value of the difference may be 4, and the average value may be 4. In terms of pinyin, as can be seen from the above description, the first character set is {ku, ba, gou, wu, wang, zhan}, and the second character set is {ku, ba}. In this case, the absolute value of the difference may also be 4, and the average value may be 4. In terms of phrases, as can be seen from the above description, the first character set is {cool bar, shopping, web site}, and the second character set is {pants bar}, the absolute value of the difference is 2, and the average value is 2.

It should be noted that, in implementations, one or more combinations of the above methods may be used to obtain multiple pieces of feature information between the character information characterizing the first trademark and the character information of the second trademark to construct the feature information set. Alternatively, the above method may also be combined with other methods to construct the feature information set, which is not specifically limited herein.

After step S304, step S306 is executed to obtain the degree of similarity between the first trademark and the second trademark based on the feature information set.

After obtaining the feature information set corresponding to the first trademark and the second trademark through the above steps, in the embodiments of the present disclosure, a machine learning algorithm may be used to automatically obtain the degree of similarity between the first trademark and the second trademark based on feature information in the feature information set.

In implementations, obtaining the degree of similarity between the first trademark and the second trademark based on the feature information set includes: inputting the feature information in the feature information set into a similarity calculation model to obtain the degree of similarity.

The similarity calculation model may be a neural network model that is obtained by pre-training and is used to calculate a degree of similarity between at least two trademarks. For example, it may be a logistic regression model, a decision tree model, etc., where a training method of the model is not redundantly described herein.

After the above description, the degree of similarity between the first trademark and the second trademark may be quickly and accurately obtained. In implementations, the method described in this embodiment may be used in a trademark application pre-judgment scenario, i.e., an applicant searches for conflicting trademarks in advance to modify or redesign a target trademark that is to be applied for to avoid application failure. The method may also be applied in a trademark application review and examination scenario, i.e., an examiner uses this method to search for registered trademark(s) that is/are similar to a target trademark submitted by an applicant for the target trademark, so as to quickly and accurately make a review result.

For example, for a target trademark of “Cool Bar Shopping Website” that is to be applied for, an applicant may send the target trademark through a terminal device thereof to a server configured to obtain a pre-judgment application result. For example, by searching the target trademark in a trademark query search engine, the target trademark is sent to a corresponding server, wherein the server corresponding to the search engine may include preprocessed and structured index information of registered trademarks. For example, for each registered trademark, engine data of the search engine may include all pieces of information that are constructed based on one or more of Chinese character information, pinyin information, classification information, registrant information and other information of the trademark. After obtaining the target trademark, the server may first conduct a rough recall process, i.e., first using simple rules, such as Chinese character matching or pinyin matching rules, and searching for similar trademark(s) that match(es) the target trademark according to pre-built index information of registered trademarks to obtain a set of similar trademarks. Such set of similar trademarks may be {“Coolby Rubik's Cube”, “Pants Bar”, “Queer”}. For each trademark in the target trademark and the set of similar trademarks, the similarity obtaining method described in this embodiment may then be used to obtain respective degree of similarity between the target trademark and each similar trademark to obtain a similarity set, for example, {5%, 43%, 34%}. Based on the similarity set, the server may then return a pre-judgment application result to the terminal device. For example, if a preset similarity threshold is set to be 80%, if a maximum value in the similarity set is not greater than the similarity threshold, the server may determine that no similar trademark in the registered trademarks exists, and may return a pre-judgment application result of “success” to the terminal device.

Apparently, in order to facilitate a user to view and perform secondary confirmation, after obtaining the set of similar trademarks and the similarity set, the server may also generate a list of similar trademarks based on the set of similar trademarks and the similarity set (for example, generating a list of similar trademarks composed of data pairs {({“Coolby Rubik's Cube”, 5%), (“Pants Bar”, 43%), (“Queer”, 34%)}), and provide the list of similar trademarks and the above-mentioned pre-judgment application result to the terminal device, to allow the terminal device to display the list of similar trademarks and the pre-judgment application result for view by the user.

In summary, in the method for obtaining trademark similarity provided in this embodiment, for a first trademark and a second trademark, an electronic device (for example, a server for calculating trademark similarity) separately obtains character information of the first trademark and character information of the second trademark, and constructs a feature information set based on the character information of the first trademark and the character information of the second trademark. The electronic device may then quickly and accurately obtain the degree of similarity between the first trademark and the second trademark based on the feature information set. In the embodiments of the present disclosure, by obtaining respective character information of two trademarks whose degree of similarity is to be obtained, the electronic device automatically constructs multiple pieces of feature information for judging the degree of similarity of these two trademarks, and in conjunction with a machine learning algorithm, quickly and accurately obtains the degree of similarity between the trademarks based on feature information between the two trademarks automatically. This method may avoid the problem of manual design rules or the problem of inaccurate calculation of manual design rules, thereby saving manpower and improving user experience.

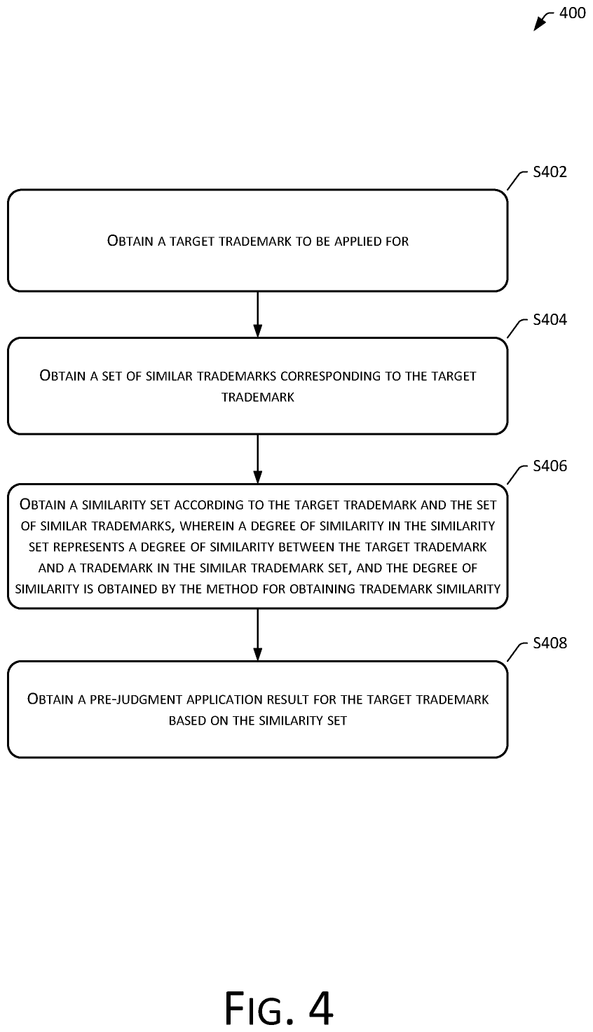

Corresponding to the above method 300, this embodiment also provides a trademark application conflict prediction method. FIG. 4 is a schematic flowchart of a trademark application conflict prediction method 400 provided by the embodiments of the present disclosure. This method 400 may be applied to an electronic device, for example, may be applied to the electronic device 102 as shown in FIG. 2. There is no special restriction herein.

As shown in FIG. 4, the method 400 provided in this embodiment may include steps S402-S408.

Step S402: Obtain a target trademark to be applied for.

Step S404: Obtain a set of similar trademarks corresponding to the target trademark.

Step S406: Obtain a similarity set according to the target trademark and the set of similar trademarks, wherein a degree of similarity in the similarity set represents a degree of similarity between the target trademark and a trademark in the similar trademark set, and the degree of similarity is obtained according to the method described in the foregoing embodiments, such as the method 300.

Step S408: Obtain a pre-judgment application result for the target trademark based on the similarity set.

In implementations, the method further includes: generating a list of similar trademarks based on the set of similar trademarks and the similarity set, wherein the list of similar trademarks includes a plurality of data pairs, and the data pairs are composed of trademarks in the set of similar trademarks and corresponding similarities of the trademarks in the similarity set.

In implementations, the method may be applied to a server. In this case, the method further includes: providing a list of similar trademarks and a pre-judgment application result to a terminal device.

In implementations, the method may be applied to a terminal device. In this case, the method further includes: displaying a list of similar trademarks and a pre-judgment application result.

In the method provided in this embodiment, for a target trademark to be applied for, a big data method may be used to perform a search using simple rules to obtain a set of similar trademarks corresponding to the target trademark. In order to improve the accuracy of a pre-judgment application result, after obtaining the list of similar trademarks through the search, this embodiment uses the method for obtaining trademark similarity as described in the foregoing embodiments (such as the method 300) to obtain a degree of similarity between the target trademark and each of the set of similar trademarks, thereby obtaining a similarity set Based on the similarity set, a pre-judgment application result for the target trademark may be accurately obtained.

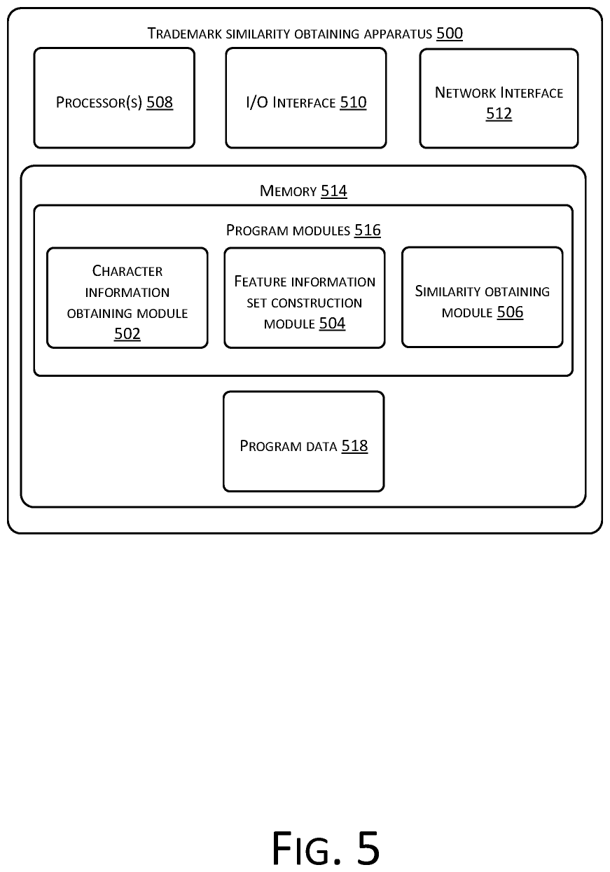

Corresponding to the foregoing embodiments, this embodiment also provides a trademark similarity obtaining apparatus, as shown in FIG. 5, which is a schematic principle block diagram of a trademark similarity obtaining apparatus provided by the embodiments of the present disclosure.

As shown in FIG. 5, the trademark similarity obtaining apparatus 500 of this embodiment includes a character information obtaining module 502, a feature information set construction module 504, and a similarity obtaining module 506.

The character information obtaining module 502 is configured to obtain character information of a first trademark and character information of a second trademark.

The feature information set construction module 504 is configured to construct a feature information set based on the character information of the first trademark and the character information of the second trademark.

In implementations, when constructing the feature information set based on the character information of the first trademark and the character information of the second trademark, the feature information set construction module 504 may be configured to: obtain a first character set based on the character information of the first trademark, and obtain a second character set based on the character information of the second trademark; and construct the feature information set based on the first character set and the second character set.

In implementations, when constructing the feature information set based on the first character set and the second character set, the feature information set construction module 504 may be configured to: calculate a union of the first character set and the second character set to obtain a target character set; and obtain an initial character vector based on the target character set, wherein each character of the initial character vector corresponds to a character in the target character set successively, and a numerical value of each character of the initial character vector is a first preset numerical value; obtain a first character vector based on the first character set and the initial character vector, and obtain a second character vector based on the second character set and the initial character vector; and construct the feature information set based on the first character vector and the second character vector.

In implementations, when obtaining the first character vector based on the first character set and the initial character vector, the feature information set construction module 504 may be configured to: set a value of a character at a corresponding position in the initial character vector to a second preset value to obtain the first character vector based on the first character set and a correspondence relationship between each character of the initial character vector and a character in the target character set.

In implementations, when constructing the feature information set based on the first character vector and the second character vector, the feature information set construction module 504 may be configured to: calculate a cosine similarity of the first character vector and the second character vector to construct the characteristic information set.

In implementations, when constructing the feature information set based on the first character set and the second character set, the feature information set construction module 504 may be configured to: calculate a Jaccard coefficient between the first character information and the second character information based on the first character set and the second character set; and construct the feature information set according to the Jaccard coefficient.

In implementations, when constructing the feature information set based on the first character set and the second character set, the feature information set construction module 504 may be configured to: construct the feature information set by calculating an edit distance between the first character information and the second character information.

In implementations, when constructing the feature information set based on the first character set and the second character set, the feature information set construction module 504 may be configured to: obtain a first length of the first character set and a second length of the second character set; and construct the feature information set by calculating an absolute value of a difference between the first length and the second length and an average value of the first length and the second length.

The similarity obtaining module 506 is configured to obtain a degree of similarity between the first trademark and the second trademark based on the feature information set.

In implementations, when obtaining the degree of similarity between the first trademark and the second trademark based on the feature information set, the similarity obtaining module 506 may be configured to: input feature information in the feature information set into a similarity calculation model to obtain the degree of similarity.

In implementations, the apparatus 500 may further include one or more processors 508, an input/output (I/O) interface 510, a network interface 512, and a memory 514. In implementations, the memory 514 may include program modules 516 and program data 518. The program modules 516 may include one or more of the foregoing modules as described in FIG. 5.

In implementations, the memory 514 may include a form of computer readable media such as a volatile memory, a random access memory (RAM) and/or a non-volatile memory, for example, a read-only memory (ROM) or a flash RAM. The memory 612 is an example of a computer readable media.

The computer readable media may include a volatile or non-volatile type, a removable or non-removable media, which may achieve storage of information using any method or technology. The information may include a computer readable instruction, a data structure, a program module or other data. Examples of computer readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

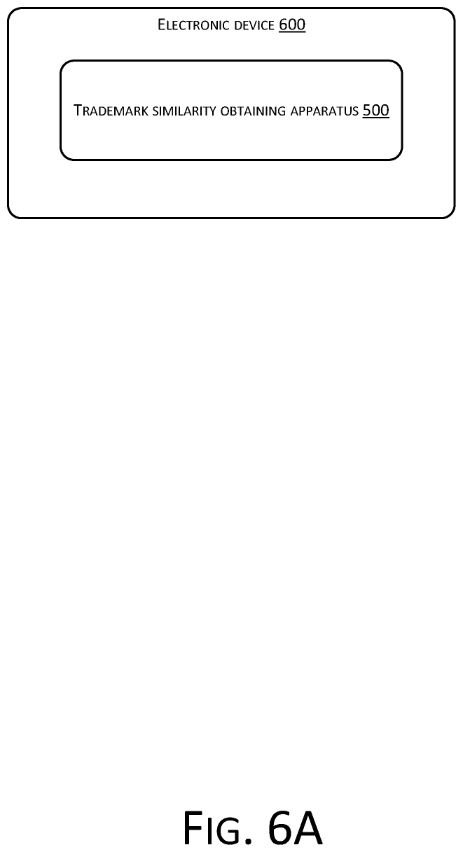

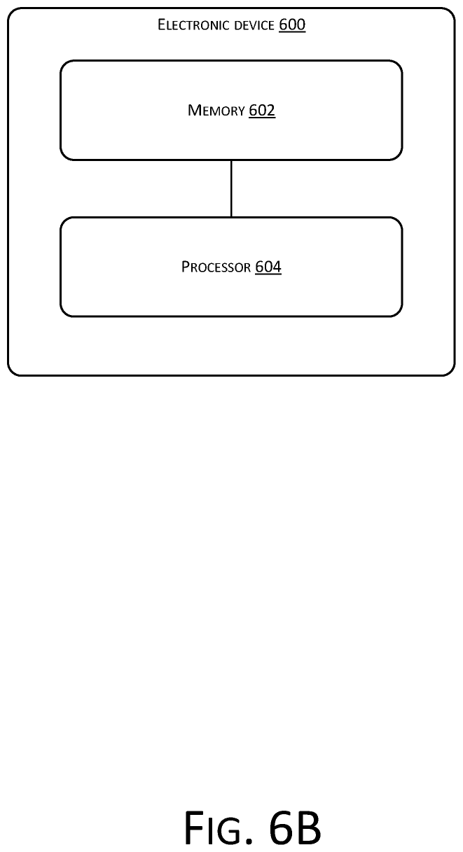

Corresponding to the foregoing embodiments, this embodiment provides an electronic device. As shown in FIG. 6a, the electronic device 600 includes a trademark similarity obtaining apparatus 500 according to any of the embodiments of the present disclosure.

In another embodiment, as shown in FIG. 6b, the electronic device 600 may include a memory 602 and a processor 604. The memory 602 is configured to store executable instructions. The processor 604 is configured to execute the method as in any of the method embodiments of the present disclosure under the control of the executable instructions.

Corresponding to the foregoing method embodiments, in this embodiment, a computer readable storage medium is also provided. The computer readable storage medium stores a computer program that is readable and executable by a computer. The computer program, when being read and run by the computer, executes the method described in any of the foregoing embodiments of the present disclosure.

The present disclosure may be a system, a method and/or a computer program product. The computer program product may include a computer readable storage medium loaded with computer readable program instructions used for enabling a processor to implement various aspects of the present disclosure.

The computer readable storage medium may be a tangible device that may hold and store instructions used by an instruction executing device. The computer readable storage medium may be, for example, but is not limited to, an electrical storage device, a magnetic storage device, an optical storage device, an electromagnetic storage device, a semiconductor storage device, or any suitable combination of the foregoing. More specific examples (a non-exhaustive list) of a computer readable storage medium include: a portable computer disk, a hard disk, random access memory (RAM), read-only memory (ROM), erasable programmable read-only memory (EPROM or flash memory), static random access memory (SRAM), portable compact disk read-only memory (CD-ROM), a digital versatile disk (DVD), a memory stick, a floppy disk, a mechanical encoding device, such as a punched card or a protruding structure in a groove with instructions stored thereon, and any suitable combination of the foregoing. The computer readable storage medium used herein is not interpreted as an instantaneous signal itself, such as radio waves or other freely propagating electromagnetic waves, electromagnetic waves propagating through waveguides or other transmission media (e.g., light pulses through fiber optic cables), or electrical signals through wired transmission.

Computer readable program instructions described herein may be downloaded from a computer readable storage medium to various computing/processing devices, or downloaded to an external computer or external storage device via a network, such as the Internet, a local area network, a wide area network, and/or a wireless network. The network may include copper transmission cables, optical fiber transmission, wireless transmission, routers, firewalls, switches, gateway computers, and/or edge servers. A network adapter card or network interface in each computing/processing device receives computer readable program instructions from the network, and forwards the computer readable program instructions for storing in a computer readable storage medium in each computing/processing device.

Computer program instructions used for performing operations of the present disclosure may be assembly instructions, instruction set architecture (ISA) instructions, machine instructions, machine-related instructions, micro-codes, firmware instructions, status setting data, or source codes or object codes written in any combination of one or more programming languages. The programming languages include object-oriented programming languages such as Smalltalk, C++, etc., and conventional procedural programming languages such as “C” language or similar programming languages. Computer readable program instructions may be executed entirely in a user's computer, executed partly in a user's computer, executed as a stand-alone software package, executed partly in a user's computer and partly in a remote computer, or executed entirely in the remote computer or server. In case of a remote computer, the remote computer may be connected to a user's computer through any type of network, including a local area network (LAN) or a wide area network (WAN), or may be connected to an external computer (e.g., connected through the Internet using an Internet service provider). In some embodiments, an electronic circuit, such as a programmable logic circuit, a field programmable gate array (FPGA), or a programmable logic array (PLA), may be customized using state information of computer readable program instructions. The electronic circuit can execute the computer readable program instructions to implement various aspects of the present disclosure.

Various aspects of the present disclosure are described with reference to flowcharts and/or block diagrams of methods, devices (systems) and computer program products according to embodiments of the present disclosure. It should be understood that each block of flowcharts and/or block diagrams, and combinations of blocks in the flowcharts and/or block diagrams, may be implemented by computer readable program instructions.

These computer readable program instructions may be provided to a processor of a general-purpose computes, a special-purpose computer, or other programmable data processing device, thereby producing a machine that causes these instructions, when executed by the processor of the computer or other programmable data processing device, to produce an apparatus that implements functions/actions specified in one or more blocks in the flowcharts and/or block diagrams. It is also possible to store these computer readable program instructions in a computer readable storage medium. These instructions enable a computer, a programmable data processing apparatus, and/or other device to operate in a specific manner. Thus, a computer readable medium storing instructions includes an article of manufacture, which includes instructions for implementing various aspects of the functions/actions specified in one or more blocks in the flowcharts and/or block diagrams.

It is also possible to load computer readable program instructions onto a computer, other programmable data processing device, or other device, so that a series of operational steps are executed on the computer, other programmable data processing apparatus, or other device to produce a computer-implemented process, so that the instructions executed in the computer, other programmable data processing apparatus, or other device implement functions/actions specified in one or more blocks in the flowcharts and/or block diagrams.

The flowcharts and block diagrams in the accompanying drawings show possible implementation architectures, functions, and operations of the systems, methods, and computer program products according to multiple embodiments of the present disclosure. In this regard, each block in a flowchart or block diagram may represent a part of a module, a program segment, or an instruction. The part of the module, the program segment, or the instruction includes one or more executable instructions used for realizing specified logical function(s). In some alternative implementations, functions marked in blocks may also occur in an order different from order(s) marked in the drawings. For example, two consecutive blocks may actually be executed substantially in parallel, or may sometimes be executed in a reverse order, depending on the functions that are involved. It should also be noted that each block in a block diagram and/or flowchart, and a combination of blocks in the block diagram and/or flowchart, may be implemented by a dedicated hardware-based system that performs specified functions or actions, or may be implemented by a combination of dedicated hardware and computer instructions. It is well known to one skilled in the art that implementations through hardware, implementations through software, and implementations through a combination of software and hardware are all equivalent.

The embodiments of the present disclosure have been described above. The above description is exemplary, and is not exhaustive, and is not limited to the disclosed embodiments. Without departing from the scope and spirit of the described embodiments, a number of modifications and changes are obvious to one of ordinary skill in the art. The choice of terms used herein is intended to best explain the principles, practical applications, or technical improvements of the various embodiments in the market, or to enable one of ordinary skill in the art to understand the various embodiments disclosed herein. The scope of the present disclosure is defined by the appended claims.

The present disclosure can be further understood using the following clauses.

Clause 1: A method for obtaining trademark similarity, comprising: obtaining character information of a first trademark and character information of a second trademark; constructing a feature information set according to the character information of the first trademark and the character information of the second trademark; and obtaining a degree of similarity between the first trademark and the second trademark based on the feature information set.

Clause 2: The method of Clause 1, wherein constructing the feature information set according to the character information of the first trademark and the character information of the second trademark comprises: obtaining a first character set according to the character information of the first trademark, and obtaining a second character set according to the character information of the second trademark; and constructing the feature information set according to the first character set and the second character set.

Clause 3: The method of Clause 2, wherein constructing the feature information set according to the first character set and the second character set comprises: calculating a union of the first character set and the second character set to obtain a target character set; obtaining an initial character vector based on the target character set, wherein each character of the initial character vector corresponds to characters in the target character set in sequence, and a value of each character of the initial character vector is a first predetermined value; obtaining a first character vector based on the first character set and the initial character vector, and obtaining a second character vector based on the second character set and the initial character vector; and constructing the feature information set based on the first character vector and the second character vector.

Clause 4: The method of Clause 3, wherein obtaining the first character vector based on the first character set and the initial character vector comprises: setting a value of a character at a corresponding position in the initial character vector to a second preset value to obtain the first character vector according to the first character set and a correspondence relationship between each character of the initial character vector and the characters in the target character set.

Clause 5: The method of Clause 3, wherein constructing the feature information set based on the first character vector and the second character vector comprises: constructing the feature information set by calculating a cosine similarity of the first character vector and the second character vector.

Clause 6: The method of Clause 2, wherein constructing the feature information set based on the first character set and the second character set comprises: calculating a Jaccard coefficient between the first character information and the second character information based on the first character set and the second character set; and constructing the feature information set based on the Jaccard coefficient.

Clause 7: The method of Clause 2, wherein constructing the feature information set based on the first character set and the second character set comprises: constructing the feature information set by calculating an edit distance between the first character information and the second character information.

Clause 8: The method of Clause 2, wherein constructing the feature information set based on the first character set and the second character set comprises: obtaining a first length of the first character set and a second length of the second character set; and constructing the feature information set by calculating an absolute value of a difference between the first length and the second length and an average value of the first length and the second length.

Clause 9: The method of Clause 1, wherein obtaining the degree of similarity between the first trademark and the second trademark based on the feature information set comprises: inputting feature information in the feature information set into a similarity calculation model to obtain the degree of similarity.

Clause 10: The method of Clause 1, wherein the first character information comprises one or more of Chinese character information, pinyin information, and phrase information corresponding to the first trademark; and correspondingly, the second character information comprises one or more of Chinese character information, pinyin information, English information, and phrase information corresponding to the second trademark.

Clause 11: A method for pre-judging conflicts between trademark applications, comprising: obtaining a target trademark to be applied for; obtaining a set of similar trademarks corresponding to the target trademark; obtaining a similarity set based on the target trademark and the set of similar trademarks, wherein a degree of similarity in the similarity set represents a degree of similarity between the target trademark and a trademark in the set of similar trademarks, and the degree of similarity is obtained using the method described in the first aspect of the present disclosure; and obtaining a pre-judgment application result of the target trademark based on the similarity set.

Clause 12: The method of Clause 11, further comprising: generating a list of similar trademarks based on the set of similar trademarks and the similarity set, wherein the list of similar trademarks includes a plurality of data pairs, and the plurality of data pairs are formed by trademarks in the set of similar trademarks and degrees of similarity in the similarity set corresponding to the trademarks.

Clause 13: The method of Clause 12, wherein the method is applied to a server, and the method further comprises: providing the list of similar trademarks and the pre-judgment application result to a terminal device.

Clause 14: The method of Clause 12, wherein the method is applied to a terminal device, and the method further comprises: displaying the list of similar trademarks and the pre-judgment application result.

Clause 15: An apparatus for obtaining trademark similarity, comprising: a character information obtaining module configured to obtain character information of a first trademark and character information of a second trademark; a feature information set construction module configured to construct a feature information set based on the character information of the first trademark and the character information of the second trademark; and a similarity obtaining module configured to obtain a degree of similarity between the first trademark and the second trademark based on the feature information set.

Clause 16: An electronic device, comprising the apparatus of Clause 15, or comprising: a memory configured to store executable instructions; a processor configured to run the electronic device to execute the method of any one of Clauses 1-14 under the control of the executable instructions.

Clause 17: A computer readable storage medium storing a computer program that is readable and executable by a computer, wherein the computer program, when read and run by the computer, executes the method of any one of Clauses 1-14.

What is claimed is:

1. A method implemented by a computing device, the method comprising:
obtaining character information of a first trademark and character information of a second trademark;
constructing a feature information set according to the character information of the first trademark and the character information of the second trademark; and
obtaining a degree of similarity between the first trademark and the second trademark based on the feature information set.

2. The method of claim 1, wherein constructing the feature information set according to the character information of the first trademark and the character information of the second trademark comprises:
obtaining a first character set according to the character information of the first trademark, and obtaining a second character set according to the character information of the second trademark; and
constructing the feature information set according to the first character set and the second character set.

3. The method of claim 2, wherein constructing the feature information set according to the first character set and the second character set comprises:
calculating a union of the first character set and the second character set to obtain a target character set;
obtaining an initial character vector based on the target character set, wherein each character of the initial character vector corresponds to characters in the target character set in sequence, and a value of each character of the initial character vector is a first predetermined value;
obtaining a first character vector based on the first character set and the initial character vector, and obtaining a second character vector based on the second character set and the initial character vector; and
constructing the feature information set based on the first character vector and the second character vector.

4. The method of claim 3, wherein obtaining the first character vector based on the first character set and the initial character vector comprises:
setting a value of a character at a corresponding position in the initial character vector to a second preset value to obtain the first character vector according to the first character set and a correspondence relationship between each character of the initial character vector and the characters in the target character set.

5. The method of claim 3, wherein constructing the feature information set based on the first character vector and the second character vector comprises:
constructing the feature information set by calculating a cosine similarity of the first character vector and the second character vector.

6. The method of claim 2, wherein constructing the feature information set based on the first character set and the second character set comprises:
calculating a Jaccard coefficient between the first character information and the second character information based on the first character set and the second character set; and
constructing the feature information set based on the Jaccard coefficient.

7. The method of claim 2, wherein constructing the feature information set based on the first character set and the second character set comprises:
constructing the feature information set by calculating an edit distance between the first character information and the second character information.

8. The method of claim 2, wherein constructing the feature information set based on the first character set and the second character set comprises:
obtaining a first length of the first character set and a second length of the second character set; and
constructing the feature information set by calculating an absolute value of a difference between the first length and the second length and an average value of the first length and the second length.

9. The method of claim 1, wherein obtaining the degree of similarity between the first trademark and the second trademark based on the feature information set comprises:
inputting feature information in the feature information set into a similarity calculation model to obtain the degree of similarity.

10. The method of claim 1, wherein the first character information comprises one or more of Chinese character information, pinyin information, and phrase information corresponding to the first trademark; and correspondingly, the second character information comprises one or more of Chinese character information, pinyin information, English information, and phrase information corresponding to the second trademark.

11. One or more computer readable media storing executable instructions that, when executed by one or more processors, cause the one or more processors to perform acts comprising:
obtaining a target trademark to be applied for;
obtaining a set of similar trademarks corresponding to the target trademark;
obtaining a similarity set based on the target trademark and the set of similar trademarks, wherein a degree of similarity in the similarity set represents a degree of similarity between the target trademark and a trademark in the set of similar trademarks; and
obtaining a pre-judgment application result of the target trademark based on the similarity set.

12. The one or more computer readable media of claim 11, the acts further comprising:
generating a list of similar trademarks based on the set of similar trademarks and the similarity set, wherein the list of similar trademarks includes a plurality of data pairs, and the plurality of data pairs are formed by trademarks in the set of similar trademarks and degrees of similarity in the similarity set corresponding to the trademarks.

13. The one or more computer readable media of claim 12, the acts further comprising:
providing the list of similar trademarks and the pre-judgment application result to a terminal device.

14. The one or more computer readable media of claim 12, the acts further comprise:
displaying the list of similar trademarks and the pre-judgment application result.

15. An apparatus comprising:
one or more processors; and
memory storing executable instructions that, when executed by the one or more processors, cause the one or more processors to perform acts comprising:
obtaining character information of a first trademark and character information of a second trademark;
constructing a feature information set according to the character information of the first trademark and the character information of the second trademark; and
obtaining a degree of similarity between the first trademark and the second trademark based on the feature information set.

16. The apparatus of claim 15, wherein constructing the feature information set according to the character information of the first trademark and the character information of the second trademark comprises:
obtaining a first character set according to the character information of the first trademark, and obtaining a second character set according to the character information of the second trademark; and
constructing the feature information set according to the first character set and the second character set.

17. The apparatus of claim 16, wherein constructing the feature information set according to the first character set and the second character set comprises:
calculating a union of the first character set and the second character set to obtain a target character set;
obtaining an initial character vector based on the target character set, wherein each character of the initial character vector corresponds to characters in the target character set in sequence, and a value of each character of the initial character vector is a first predetermined value;
obtaining a first character vector based on the first character set and the initial character vector, and obtaining a second character vector based on the second character set and the initial character vector; and
constructing the feature information set based on the first character vector and the second character vector.

18. The apparatus of claim 16, wherein constructing the feature information set based on the first character set and the second character set comprises:
calculating a Jaccard coefficient between the first character information and the second character information based on the first character set and the second character set; and
constructing the feature information set based on the Jaccard coefficient.

19. The apparatus of claim 16, wherein constructing the feature information set based on the first character set and the second character set comprises:
constructing the feature information set by calculating an edit distance between the first character information and the second character information.

20. The apparatus of claim 16, wherein constructing the feature information set based on the first character set and the second character set comprises:
obtaining a first length of the first character set and a second length of the second character set; and
constructing the feature information set by calculating an absolute value of a difference between the first length and the second length and an average value of the first length and the second length.
